(19) United States
(12) Patent Application Publication
(10) Pub. No.: US 2017/0050250 A1
(43) Pub. Date: Feb. 23, 2017

(54) Feed Finger Positioning Apparatus And Methods

(71) Applicant: Williams & White Machine Inc., Burnaby (CA)

(72) Inventors: Justin Williams, Vancouver (CA); Glen Springle, Maple Ridge (CA); Theo Pacson, Burnaby (CA); Sirine Maalej, Burnaby (CA); Brodie Shute, Vancouver (CA); Bryan Gromadzki, North Vancouver (CA); Thomas Charles Savage, Abbotsford (CA); Trevor Thomas Savage, Langley (CA)

(21) Appl. No.: 15/240,967

(22) Filed: Aug. 18, 2016

Related U.S. Application Data
(60) Provisional application No. 62/208,491, filed on Aug. 21, 2015.
(60) Provisional application No. 62/209,302, filed on Aug. 24, 2015.

(51) Int. Cl. B23D 63/00; B23D 63/12

(52) U.S. Cl. CPC B23D 63/005; B23D 63/12

(57) ABSTRACT

An apparatus for positioning a feed finger engageable with a saw blade includes: a first motion system configured to move the feed finger in a first degree of freedom; a second motion system configured to move the feed finger in a second degree of freedom different than the first degree of freedom; and a third motion system configured to move the feed finger in a third degree of freedom different than the first and second degrees of freedom. The third degree of freedom includes linear translational motion in a direction having a non-zero component normal to a plane of the saw blade.

### CROSS-REFERENCE TO RELATED APPLICATIONS

This application claims the benefit of priority from U.S. Patent Application No. 62/208,491 filed on Aug. 21, 2015 and 62/209,302 filed on Aug. 24, 2015, both of which are hereby incorporated herein by reference.

### FIELD OF THE INVENTION

Illustrative embodiments of the present invention generally relate to saw grinding machines, and more particularly to apparatus and methods for positioning a feed finger engageable with a saw blade.

### BACKGROUND

Computer Numerical Control (CNC) saw grinding machines are used to sharpen saw teeth of saw blades.

For example, in an embodiment disclosed in the Applicant's prior PCT publication no. WO 2013/091110, a CNC saw grinding apparatus is used to move a saw blade into a loading position and then into a sharpening position, to rotatably advance a tooth of the saw blade, to secure the saw blade in a tooth grinding position, to grind the tooth, and to continue to rotatably advance and grind each tooth of the blade. To rotatably advance each successive tooth of the saw blade for grinding, a feed finger sub-assembly 24 shown in FIG. 8 of WO 2013/091110 has a feed finger 102 which can move in a first degree of freedom by pivoting in the plane of the saw blade, and in a second degree of freedom by extending horizontally in the plane of the saw blade.

Similarly, other prior CNC saw grinding machines have also conventionally employed a feed finger having no more than two degrees of freedom. A partial exception can be found in U.S. Pat. No. 6,907,809, which provides a pneumatic cylinder and a biasing spring that allow a feed finger to be pivoted over only a very short range of small-radius arcuate motion to move the finger into and out of the plane of the saw blade, while larger ranges of motion parallel to the plane of the saw blade are permitted.

### SUMMARY

In accordance with one illustrative embodiment, an apparatus for positioning a feed finger engageable with a saw blade includes a first motion system configured to move the feed finger in a first degree of freedom. The apparatus further includes a second motion system configured to move the feed finger in a second degree of freedom different than the first degree of freedom, and a third motion system configured to move the feed finger in a third degree of freedom different than the first and second degrees of freedom. The third degree of freedom includes linear translational motion in a direction having a non-zero component normal to a plane of the saw blade.

In comparison to prior systems involving a feed finger with no more than two degrees of freedom, the present inventors have found that for certain types of saw blades, the ability of the apparatus to move the feed finger linearly in the third degree of freedom tends to diminish the statistical risk that retracting the feed finger from a gullet in the saw blade may inadvertently cause the finger to get stuck in the gullet, an occurrence which could cause the blade to unexpectedly rotate opposite to its desired cycling direction. The ability to move the feed finger linearly in the third degree of freedom also enables precise automated centering of the feed finger tip on each saw tooth, which is particularly advantageous for teeth having angular face dimensions.

In addition, by permitting its feed finger to move in three degrees of freedom, such an apparatus advantageously permits a user to easily select between operation in either a side-shift cycling mode or an over-the-top cycling mode, thereby allowing a user to achieve improved feeding efficiency (cycling frequency) for a particular situation, in view of the particular tooth styles and geometries of the particular saw blade.

In accordance with another illustrative embodiment, a method of positioning a feed finger engageable with a saw blade includes moving the feed finger in a first degree of freedom, moving the feed finger in a second degree of freedom different than the first degree of freedom, and moving the feed finger in a third degree of freedom different than the first and second degrees of freedom. The third degree of freedom includes linear translational motion in a direction having a non-zero component normal to a plane of the saw blade.

Other aspects and features of illustrative embodiments of the present invention will become apparent to those ordinarily skilled in the art upon review of the following description of such embodiments in conjunction with the accompanying figures.

### BRIEF DESCRIPTION OF THE DRAWINGS

In drawings which illustrate embodiments of the invention,

FIG. 1 is an isometric view of a feed finger positioning apparatus according to an illustrative embodiment of the invention, shown with several protective outer skirts removed for ease of illustration;

FIG. 2 is a back view of the feed finger positioning apparatus of FIG. 1;

FIG. 3 is a top view of an X-motion system of the feed finger positioning apparatus of FIG. 1 with some components removed for ease of illustration;

FIG. 4 is a back-left view of a Z-motion system of the feed finger positioning apparatus of FIG. 1 with some components removed for ease of illustration;

FIG. 5 is a right-front view of a Y-motion system of the feed finger positioning apparatus of FIG. 1 with some components removed for ease of illustration;

FIG. 6 is a top view of a feed finger of the apparatus of FIG. 1 in a side-switch cycling mode;

FIG. 7 is a rear right view of a feed finger of the apparatus of FIG. 1 in an over-the-top cycling mode;

FIG. 8 is a front view of the feed finger positioning apparatus of FIG. 1;

FIG. 9 is a top view of the feed finger positioning apparatus of FIG. 1;

FIG. 10 is a bottom view of the feed finger positioning apparatus of FIG. 1;

FIG. 11 is a left view of the feed finger positioning apparatus of FIG. 1;

FIG. 12 is a right view of the feed finger positioning apparatus of FIG. 1; and

FIGS. 13A to 13C provide an exploded view of the feed finger positioning apparatus of FIG. 1.

### DETAILED DESCRIPTION

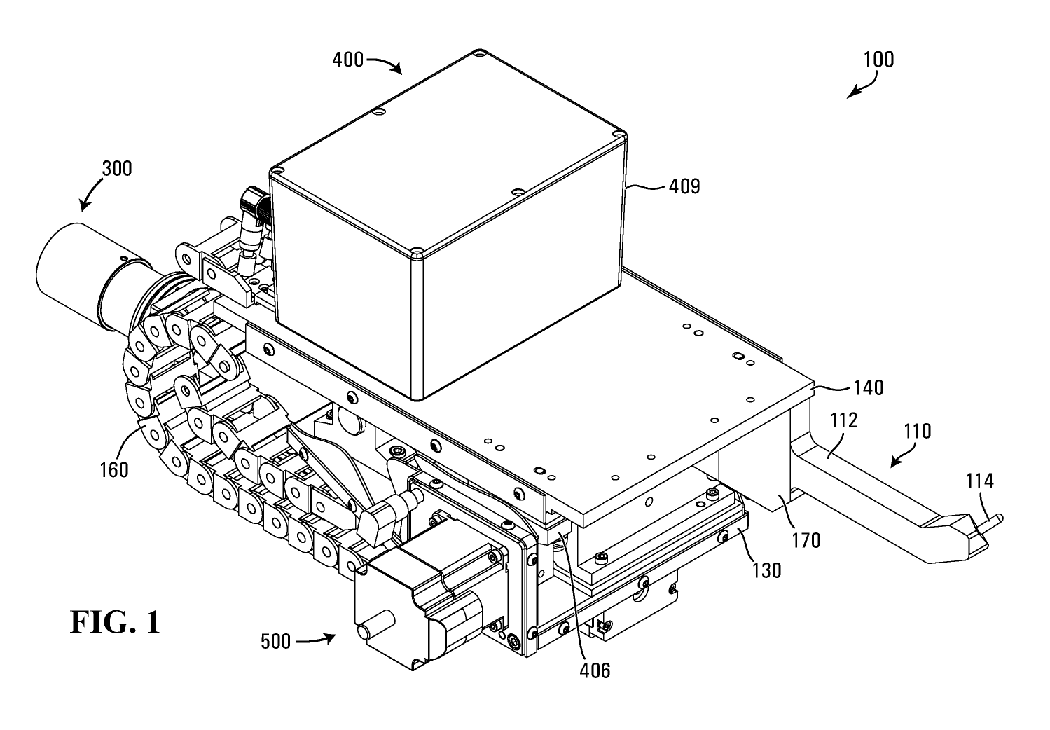

Referring to FIGS. 1 and 7, an apparatus according to a first embodiment of the invention is shown generally at 100. In this embodiment, the apparatus 100 is configured for positioning a feed finger 110 engageable with a saw blade 120. To achieve this, in the present embodiment, the apparatus 100 includes a first motion system 300 configured to move the feed finger in a first degree of freedom, a second motion system 400 configured to move the feed finger in a second degree of freedom different than the first degree of freedom, and a third motion system 500 configured to move the feed finger in a third degree of freedom different than the first and second degrees of freedom. In this embodiment, the third degree of freedom includes linear translational motion in a direction having a non-zero component normal to a plane of the saw blade 120. More particularly, in this embodiment the direction is normal to the plane of the saw blade.

In this embodiment, the apparatus 100 is a component of a larger computer controlled multiple axis grinding machine (not shown) for grinding saw blades, as disclosed in the Applicant's above-noted commonly owned PCT publication no. WO 2013/091110. Consequently, in this embodiment the apparatus 100 includes chain-link wire guides such as those shown at 160 in FIG. 1, through which both electrical power wires and computer control wires are routed, to protect the wires against chafing or other wear as the various components of the apparatus 100 move as described below.

### Feed Finger

Referring to FIGS. 1, 2, 6 and 7, in this embodiment the feed finger 110 includes a feed finger shaft 112 and a feed fingertip 114, which in this embodiment includes a carbide tip. In this embodiment, the feed finger 110 is bolted to a lower surface of an upper plate 140 of the apparatus 100. To strengthen the connection of the feed finger 110 to the upper plate 140, in this embodiment an arm gusset 170 shown in FIG. 1 is bolted to the upper plate 140 adjacent the feed finger 110, and three dowels 172 connect the feed finger 110 to the arm gusset 170.

In this embodiment the feed fingertip 114 has an angular offset relative to a normal to the plane of the saw blade 120. More particularly, in this embodiment the shaft 112 lies in a plane parallel to that of the saw blade 120 such that a normal to a rear surface 118 of the shaft 112 is parallel with a normal to the saw blade, and the fingertip 114 extends from an angled surface 116 that extends frontward and upward from the rear surface 118 by an angle of 42 degrees. Thus, in this embodiment the angular offset of the feed fingertip relative to a normal to the saw blade plane is 42 degrees.

In this regard, such an angular offset is advantageous, particularly for certain types of saw blades. The teeth of some saw blades have shear face angles, and in some cases alternating teeth have opposite shear angles. In such cases, it is important to accurately position the feed fingertip 114 in the center of each tooth, to achieve an accurate and even grind. Therefore, in this embodiment the angular offset of the fingertip 114 exceeds the largest expected shear angle of typical saw blades, which ensures that the fingertip 114 can properly contact the center of each tooth, and thereby facilitates accurate automated side locating of the feed fingertip 114. Conversely, however, the angular offset is not excessively larger than the largest expected shear angle: in this regard, maintaining a smaller angular offset advantageously permits the feed fingertip 114 to laterally fit into and out of smaller gullets.

### X-Motion System

Referring to FIGS. 1, 2 and 3, in this embodiment, the first motion system 300 is configured to linearly translate the feed finger along a first axis. More particularly, in this embodiment the first axis is denoted as the X-axis and extends horizontally in a direction parallel to the plane of the saw blade.

In this embodiment, the first motion system 300 moves the feed finger 110 in the X-axis direction by moving a feed finger base plate 130 to which the feed finger 110 is indirectly connected. To achieve this, in this embodiment the first motion system 300 includes a first motor 302, which in this embodiment is a stepper motor. A shaft or ball screw 304 is coupled at one end to the motor 302 via a coupler shown generally at 306. The ball screw 304 extends along a rail basket 308 and passes through a slider block 310 with which the ball screw 304 threadedly engages. In this embodiment, the slider block 310 has a shape complementary to that of side rails 312 and 314, and has ball bearings along its sides that engage the side rails 312 and 314, to allow the slider block 310 to slide within the rail basket 308 in the direction of the ball screw 304, i.e., in the X-axis direction. In this embodiment, the slider block 310 is rigidly coupled to a spacer block 320, which in turn is rigidly coupled to a lower surface of the feed finger base plate 130, to which the feed finger 110 is indirectly connected. Consequently, rotation of the first motor 302 extends or retracts the ball screw 304, which moves the slider block 310 and thus the entire finger feed base plate 130 in the X-axis direction, thereby moving the feed finger 110 in the X-axis direction.

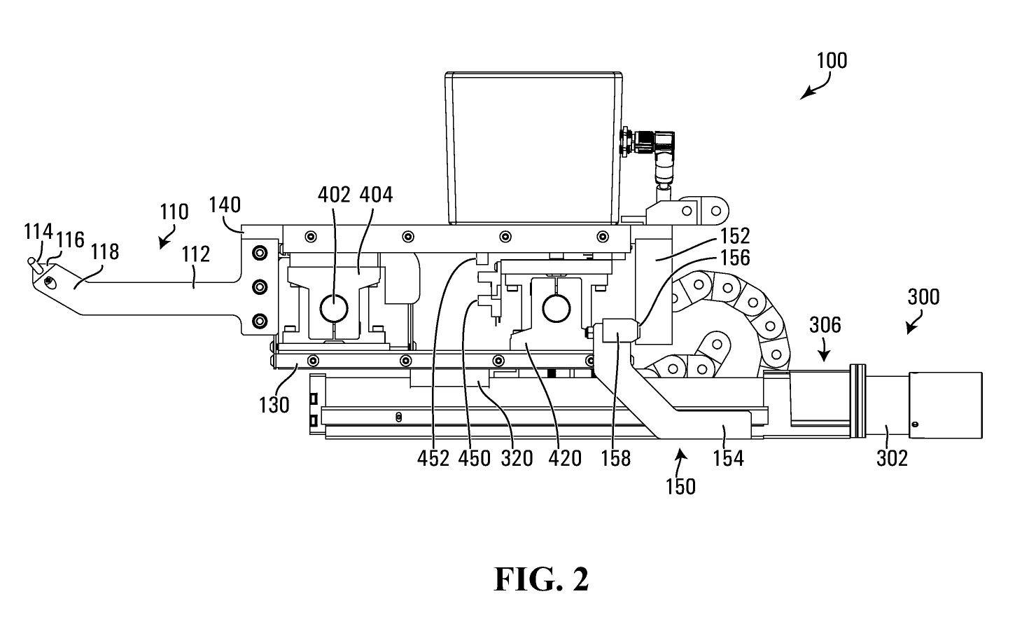

In this embodiment, the first motion system 300 further includes a limiter shown generally at 150 in FIG. 2, which limits the motion of the feed finger 110 in the X-axis direction. In this embodiment, the limiter 150 includes a moveable stopper 152 engageable with a fixed bumper 154. The fixed bumper 154 is bolted to the same surface as the first motion system 300 and does not move relative to the rail basket 308 of the first motion system; the location at which the fixed bumper 154 is mounted serves to define a maximum travel distance in the X-direction for the feed finger 110. The moveable stopper 152 has a linear recess 156 which is complementary to the protruding shape of a dead stop block 158 connected to the fixed bumper 154, so that when the feed finger 110 reaches its maximum desired travel distance in the X-direction, the moveable stopper 152 abuts against the dead stop block 158 of the fixed bumper, thereby preventing the feed finger from moving further away from the motor 302 in the X-direction.

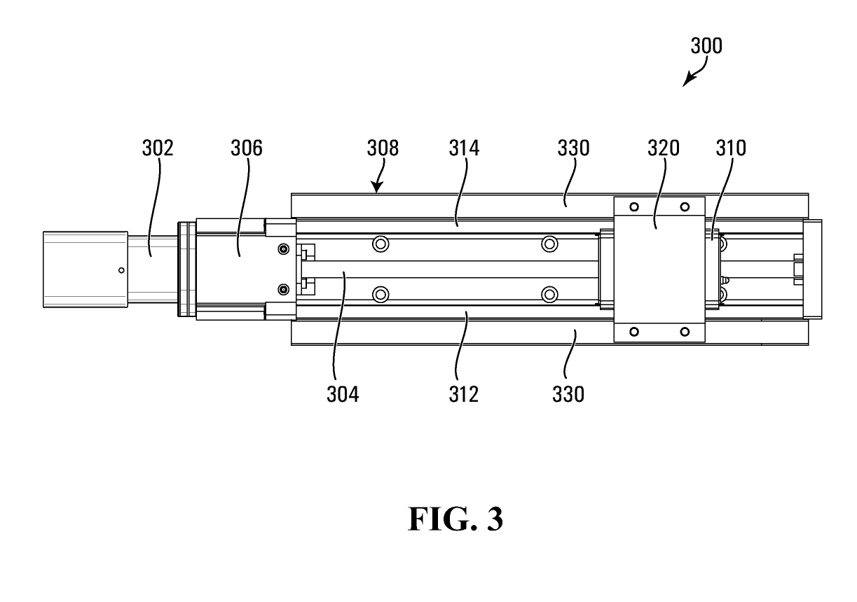

In this embodiment, the first motion system 300 further includes side baffles 330 shown in FIG. 3, for reducing the likelihood of fluid contamination of the rail basket 308. Also, if desired, extendable accordion-style barriers (not shown) may be provided on either side of the slider block 310 and spacer block 320, to keep metal filings, dust or other contaminants out of the rail basket 308.

### Z-Motion System

Referring to FIGS. 1, 4 and 5, to move the feed finger 110 in the second degree of freedom, in this embodiment the second motion system 400 is configured to rotate the feed finger about a second axis. More particularly, in this embodiment the second axis is denoted as the Y-axis and extends horizontally in a direction normal to the plane of the saw blade. Thus, in this embodiment the first axis (X-axis) and the second axis (Y-axis) are orthogonal.

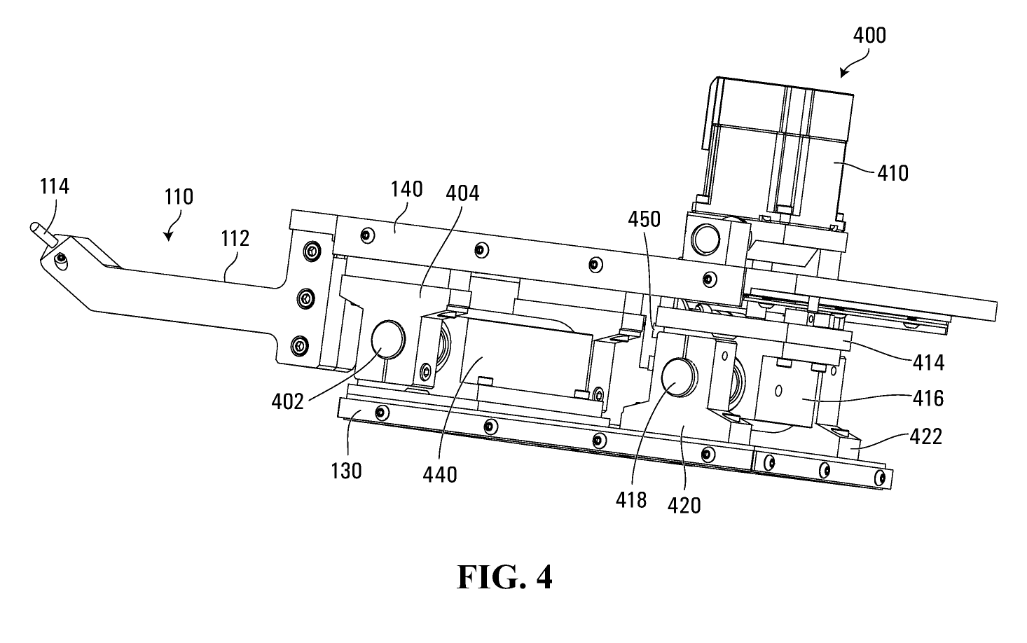

More particularly, in this embodiment the second axis is the central axis of a cylindrical shaft 402 shown in FIG. 4. In this embodiment, the upper plate 140 of the apparatus 100 to which the feed finger 110 is mounted is rigidly coupled to the cylindrical shaft 402 via two inverted pillow blocks 404 and 406. The pillow blocks 404 and 406 are rigidly mounted to the bottom side of the upper plate 140 at opposite sides (front and rear) thereof, and are rigidly coupled to opposite end regions of the cylindrical shaft 402, such that the shaft does not rotate relative to the upper plate 140, but rather, the upper plate 140 and the shaft 402 rotate in tandem. The cylindrical shaft 402 passes through a rotational bushing assembly 440, which in this embodiment is a Thomson linear bearing having oilless bushings that allow the cylindrical shaft 402 to freely rotate about and slide along its central axis. Thus, in this embodiment the entire upper plate 140, and thus the feed finger 110 connected to the upper plate, are both pivotable about and slidable along the central axis of the cylindrical shaft 402 (Y-axis).

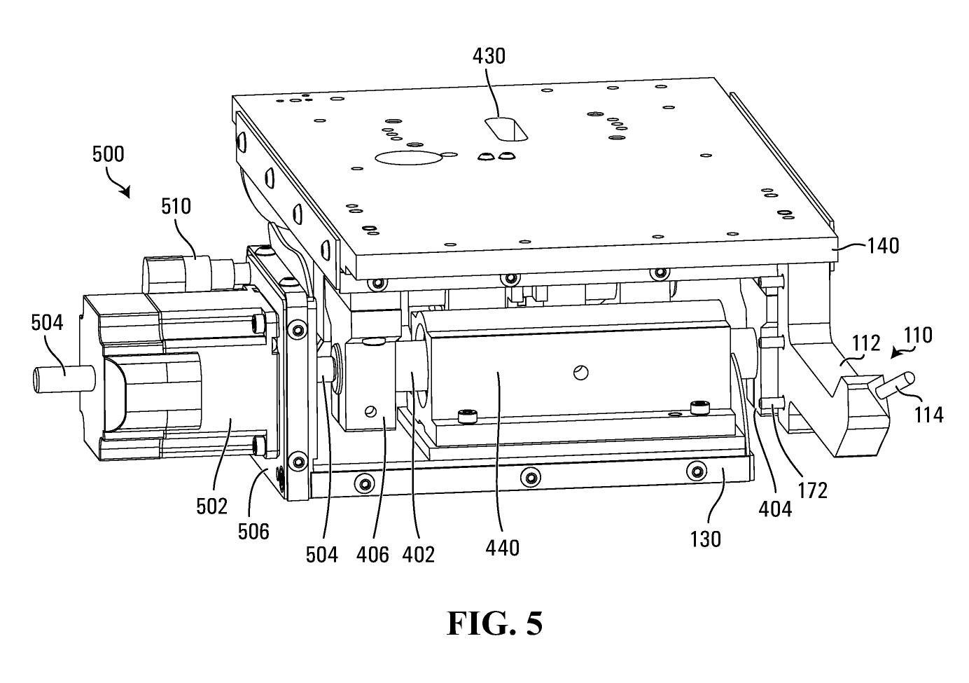

In this embodiment, housed within a motor casing 409 is a second motor 410, which in this embodiment includes a stepper motor, mounted to the upper plate 140. The motor 410 rotates a motor shaft 412 which extends downward through an elongated opening 430 in the upper plate 140, which is elongated in the left-right direction as shown in FIG. 5. Referring back to FIG. 4, the motor shaft 412 extends downward through this elongated opening 430, and is threadedly coupled to a bushing base plate 414, to which a rotational bushing assembly 416 is bolted. In this embodiment, the rotational bushing assembly 416 is a Thomson linear bearing comprising oilless bushings that allow it to freely rotate about and slide along the second cylindrical shaft 418. The second cylindrical shaft 418 is rigidly coupled at its ends to two pillow blocks 420 and 422, which in turn are rigidly mounted to the feed finger base plate 130. In this embodiment, the motor 410 has an internal spinning thread (not shown) which causes the motor shaft 412 to axially extend and retract from the motor 410 without rotating about its axis. More particularly, in this embodiment the motor 410 includes a Thomson Motorized Lead Screw Stepper Motor Linear Actuator, Model No. ML23A300N having a rotating nut configuration, in which the motor rotates an internal threaded nut (not shown) to extend or retract the motor shaft 412 without rotating the motor shaft 412. Thus, when the motor 410 extends or retracts the motor shaft 412, the motor 410 and upper plate 140 either rise or fall relative to the bushing base plate 414, thereby causing the entire upper plate 140 to pivot about the cylindrical shaft 402, thereby causing the feed finger 110 to rotate about the cylindrical shaft 402.

Moreover, the rotational bushing assembly 416 co-operates with the elongated opening 430 in the upper plate 140 through which the motor shaft 412 extends, to allow the motor 410 and motor shaft 412 to slightly pivot about the second cylindrical shaft 418 as the upper plate 140 pivots about the cylindrical shaft 402. This approach allows the motor 410 and motor shaft 412 to effectively remain along an arc centered about the cylindrical shaft 402, rather than attempting to force the motor and shaft to remain vertical as the upper plate 140 pivots. This approach advantageously avoids mismatch between vertical motion of the motor and arcuate motion of the upper plate, and the corresponding wear, jamming or backlash that could result from such a mismatch.

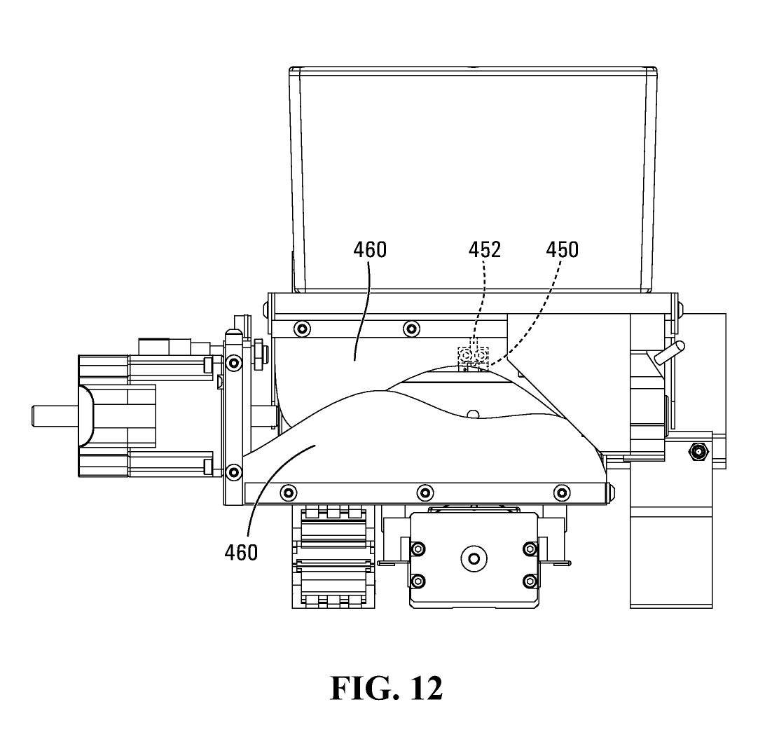

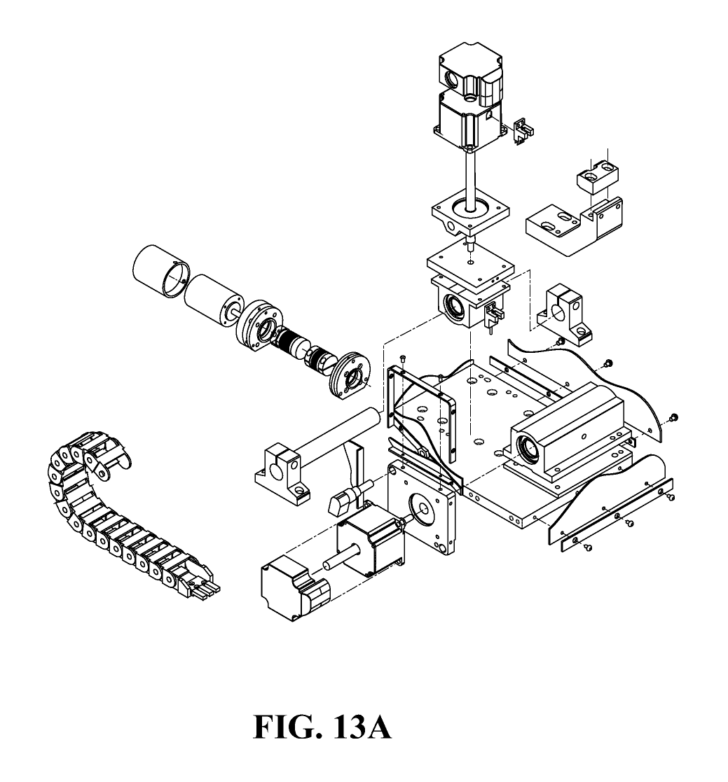

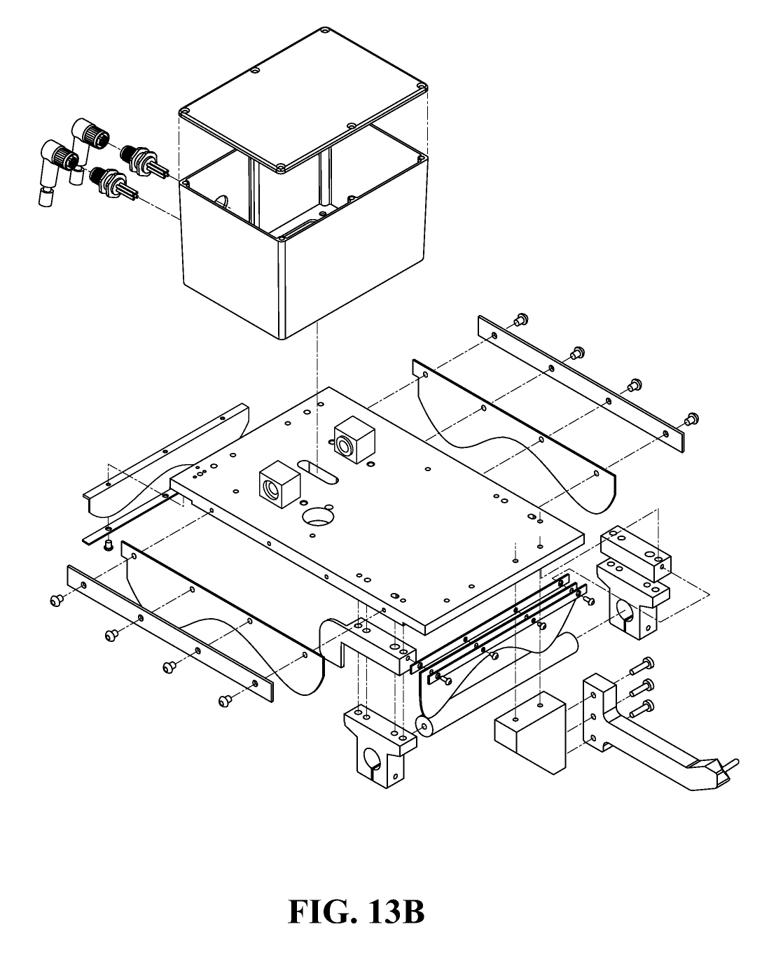

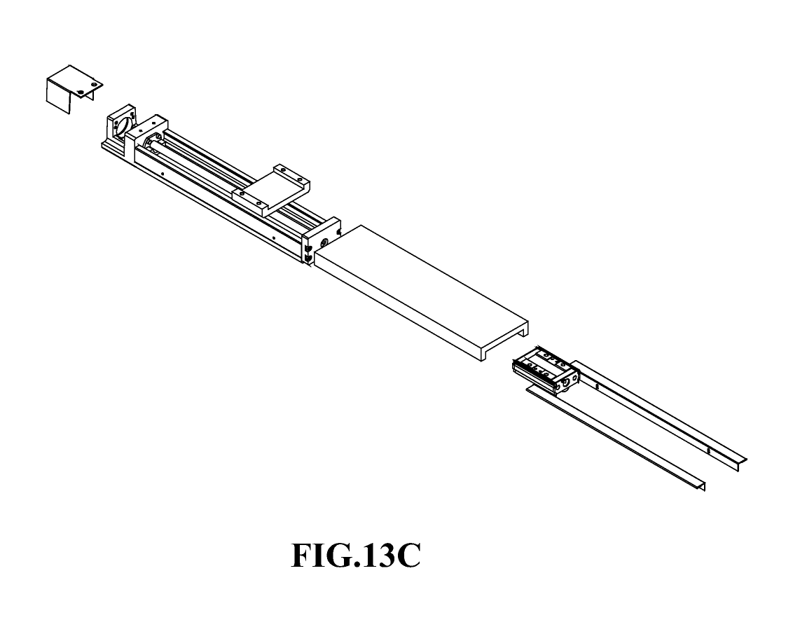

Referring to FIGS. 2, 4, 8 and 12, in this embodiment, the second motion system 400 further includes an upper plate elevation sensor 450. More particularly, in this embodiment the sensor 450 includes a photomicrosensor comprising two spaced apart plates, one of the plates transmitting infrared light along the y-axis direction to the other. The sensor 450 is affixed to the rotational bushing assembly 416, which in turn is connected to the feed finger base plate 130 via the second cylindrical shaft 418 and the pillow blocks 420 and 422. A horizontal side of an L-shaped bracket 452 is attached to the bottom surface of the upper plate 140 adjacent the second motor 410, such that the vertical side of the “L” extends vertically downward. When the feed finger 110 is in its highest position, which corresponds to the lowest possible position of the second motor 410, the L-shaped bracket blocks the infrared light from being transmitted between the two plates of the sensor 450. As the feed finger 110 is moved to a lower position by pivoting the feed fingertip 114 downward about the cylindrical shaft 402, the motor 410 and upper plate 140 rise further away from the rotational bushing assembly 416 and sensor 450, until the L-bracket attached to the upper plate 140 no longer blocks the infrared transmission between the plates of the photomicrosensor. If desired, the photomicrosensor may have two or more pairs of transmitter/receiver plates at different heights, to yield more refined information about the current height of the feed finger 110 based on how many of the transmitter/receiver pairs are currently being blocked by the L-bracket. Alternatively, assuming the initial positions of the upper plate 140 and feed finger 110 are known, a more precise determination of the current height of the feed finger 110 can be obtained from the records of the second motor 410 itself with respect to the up and down steps that it has taken.

Referring back to FIGS. 1 and 4, in this embodiment, in view of the fact that the feed finger shaft 112 is expected to be closer to horizontal than to vertical in normal operation, it will be appreciated that the pivotal or rotational motion of the feed fingertip about the Y-axis (cylindrical shaft 402) is in some ways similar to vertical motion along a Z-axis that is orthogonal to both the X- and Y-axes. When the feed finger shaft 112 is precisely horizontal, all of its rotational motion about the cylindrical shaft 402 is in the Z-axis direction; more generally, as the feed finger shaft 112 pivots about the cylindrical shaft 402 by a nonzero angle θ away from horizontal, the Z-axis component of the motion of the feed fingertip 114 will be equal to the magnitude of its arcuate motion multiplied by COS(θ). Consequently, as a hypothetical example, if the feed finger 110 is angled by no more than about 25 degrees from horizontal, then the Z-axis component of the motion of the feed fingertip 114 will exceed 90% of its total arcuate motion.

It will therefore be recognized that the approach of the present embodiment, by enabling the feed fingertip 114 to rotate about the Y-axis, is merely one example of a way in which the second degree of freedom may be provided to the feed fingertip. For example, in an alternative embodiment, the second degree of freedom may include linear translation in the Z-axis direction, so that the first, second and third motion systems 300, 400 and 500 are configured to linearly translate the feed finger along a first axis, a second axis and a third axis, respectively, wherein the axes are orthogonal. More particularly, to achieve this, one such alternative embodiment involves: removing the second cylindrical shaft 418, the rotational bushing assembly 416 and the pillow blocks 420 and 422, and replacing them with a simple rigid threaded mounting block, so that extension or retraction of the motor shaft 412 by the motor 410 vertically raises and lowers the upper plate 140; detaching and decoupling the upper plate 140 from the cylindrical shaft 402; and moving both the motor 410 and threaded mounting block closer to the center of the upper plate 140.

### Y-Motion System

Referring to FIGS. 1, 4 and 5, in this embodiment the third motion system 500 is configured to linearly translate the feed finger 110 in a direction having a non-zero component normal to a plane of the saw blade.

More particularly, in this embodiment the third motion system 500 is configured to linearly translate the feed finger 110 along a third axis, which in this embodiment is a normal to a plane of the saw blade 120. Thus, in this embodiment the second axis about which the second motion system 400 provides rotational motion and the third axis about which the third motion system 500 provides translational motion are parallel.

In this embodiment, the third motion system 500 shares some components with the second motion system 400, including the pillow blocks 404 and 406 that provide rigid connections between the upper plate 140 and the cylindrical shaft 402 as described above, and the rotational bushing assembly 440 which is rigidly connected to the feed finger base plate 130. In this embodiment, the rotational bushing assembly 440 not only permits the cylindrical shaft 402 to rotate therein as described above in connection with Z-motion, but also permits the cylindrical shaft 402 to slide in its axial direction (Y-motion), at least until one of the pillow blocks 404 or 406 abuts the rotational bushing assembly 440.

In this embodiment, the third motion system 500 further includes a third motor 502, which in this embodiment includes a stepper motor that extends and retracts a motor shaft 504 along the axial direction of the cylindrical shaft 402. In this embodiment, the motor shaft 504 extends rearward from the third motor 502 through a stepper flange plate 506, then ends at a threaded cylindrical tip portion (not shown) having a narrower diameter than the remainder of the motor shaft 504. Also in this embodiment, the cylindrical shaft 402 has a complementary aperture defined at its front end, the complementary aperture comprising an outer wider-diameter aperture portion to accommodate a main portion of the motor shaft 504, followed by an inner narrower-diameter aperture portion to accommodate the narrower tip of the motor shaft 504. The tip portion of the motor shaft 504 is threadedly engaged with threads of the inner narrower-diameter aperture portion of the cylindrical shaft 402, and is secured therein by a double nut (not shown). In this embodiment, as with the second motor 410, the third motor 502 has an internal spinning thread (not shown) which allows it to extend and retract the motor shaft 504 without rotating the motor shaft 504 about its central axis. More particularly, in this embodiment the motor 502 includes a Thomson Motorized Lead Screw Stepper Motor Linear Actuator, Model No. ML23A300N having a rotating nut configuration, in which the motor rotates an internal threaded nut (not shown) to extend or retract the motor shaft 504 without rotating the motor shaft 504. The motor shaft 504 can, however, rotate within the internal nut of the motor when necessary, in order to accommodate the small range of rotational motion that would tend to occur when the Z-motion system 400 pivots the upper plate 140, pillow blocks 404 and 406 and cylindrical shaft 402 in tandem about the central axis of the cylindrical shaft 402 as described above, with the rotation of the cylindrical shaft 402 driving a corresponding rotation of the motor shaft 504 within the internal threaded nut of the motor 502. Thus, when the third motor 502 pushes the motor shaft 504 in the Y-axis direction toward the rotational bushing assembly 440, the motor shaft 504 pushes against the complementary aperture of the cylindrical shaft 402, thereby sliding the cylindrical shaft 402 in its axial direction through the rotational bushing assembly 440. It will be recalled that the entire upper plate 140 is rigidly coupled to the cylindrical shaft 402 via the pillow blocks 404 and 406, and is otherwise supported only through the rotational bushing assembly 416 which is coupled to, but free to rotate about and slide along, the second cylindrical shaft 418, which is parallel to the cylindrical shaft 402. Consequently, actuation of the third motor 502 to extend or retract the motor shaft 504 in the Y-axis direction toward or away from the rotational bushing assembly 440 causes the entire upper plate 140, including the feed finger 110, to slide in the Y-axis direction.

In this embodiment, the third motion system 500 further includes a proximity sensor 510, for detecting the proximity of the upper plate 140 as it slides along the Y-axis. Alternatively, assuming the initial position of the upper plate 140 is known, the current position of the upper plate 140 along the Y-axis can be determined more precisely from records of the cycles completed by the third motor 502.

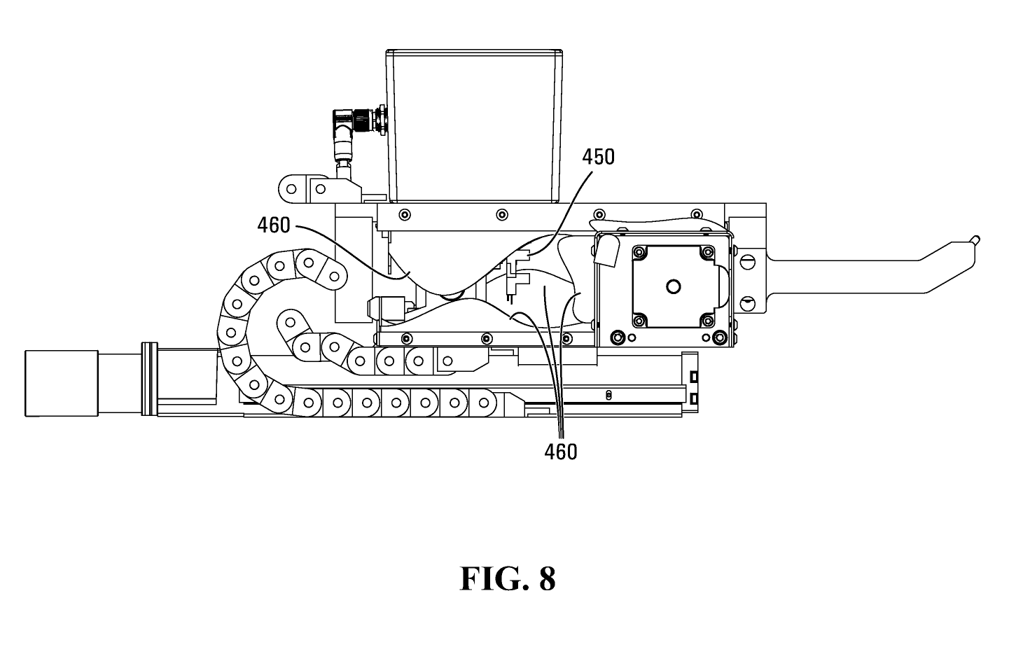

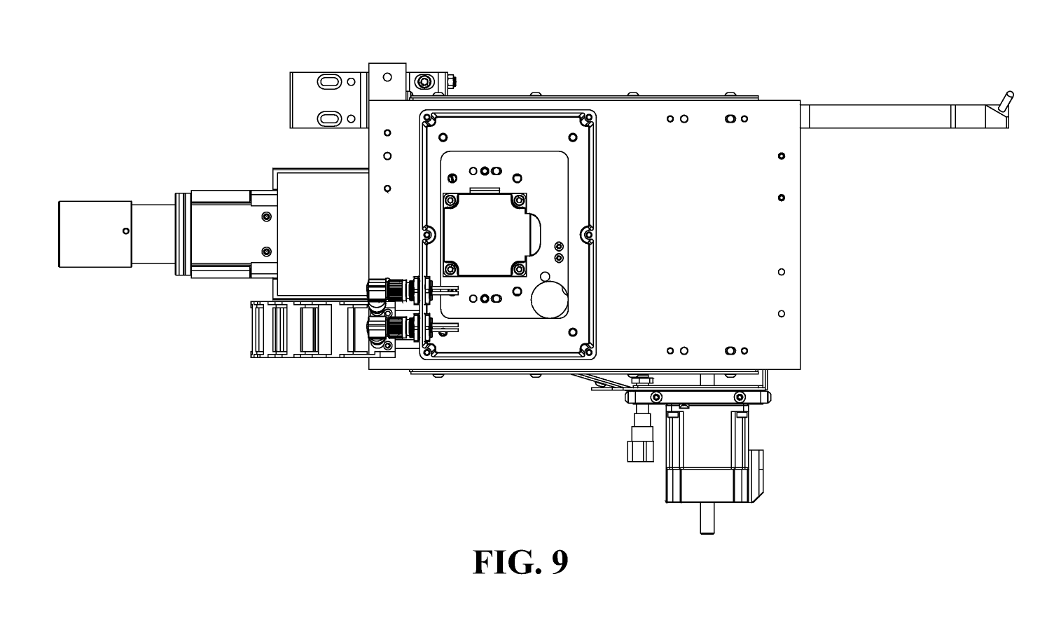

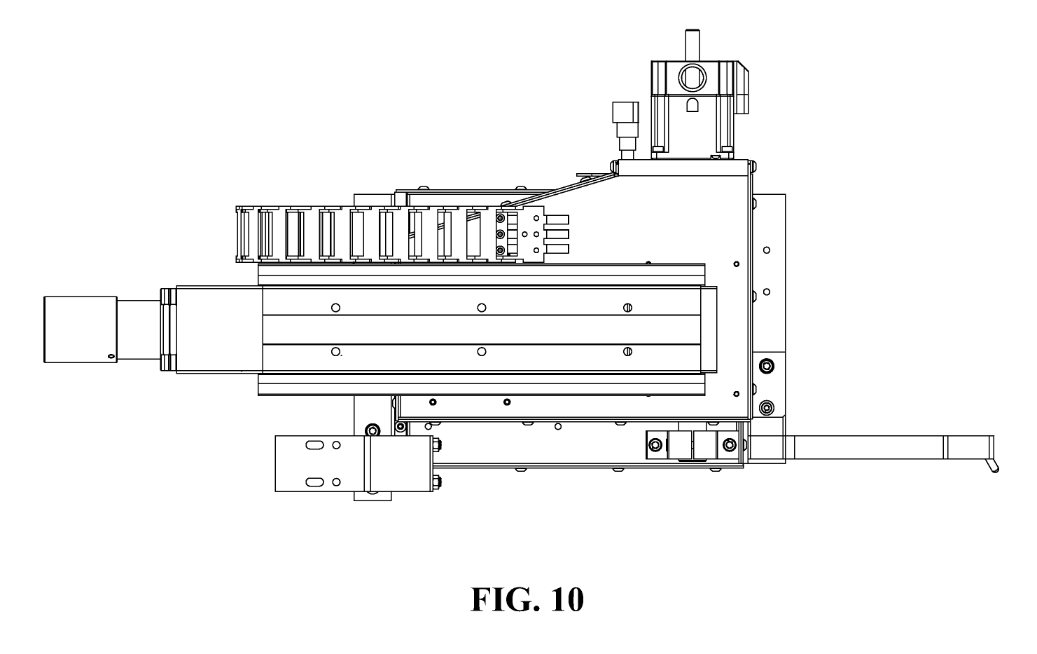

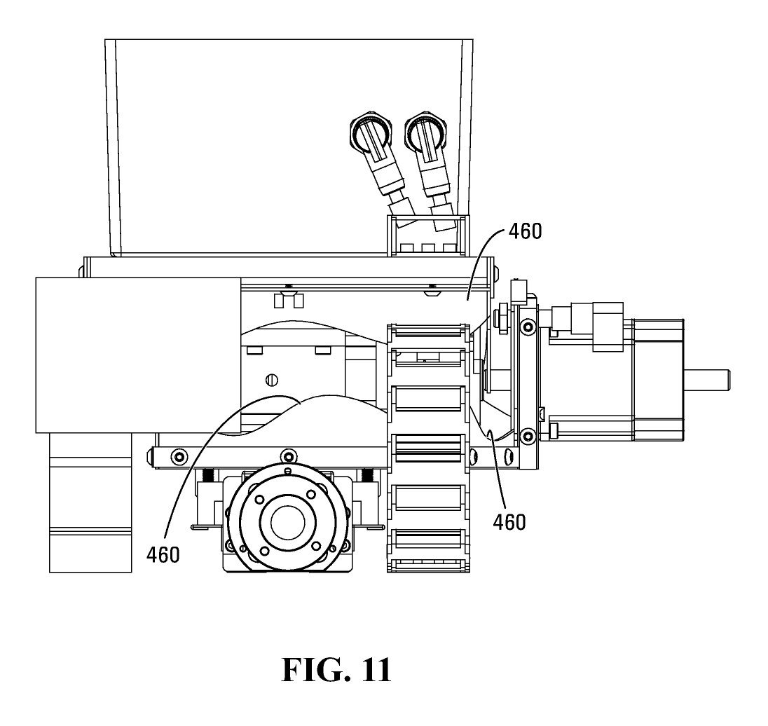

Referring to FIGS. 8, 11 and 12, in this embodiment the second and third motion systems 400 and 500 each include a number of protective skirts such as those shown at 460.

### Operation

Referring to FIGS. 1, 6 and 7, in this embodiment, the apparatus 100 is configurable between at least a side-shift cycling mode and an over-the-top cycling mode, as well as other cycling modes as discussed below.

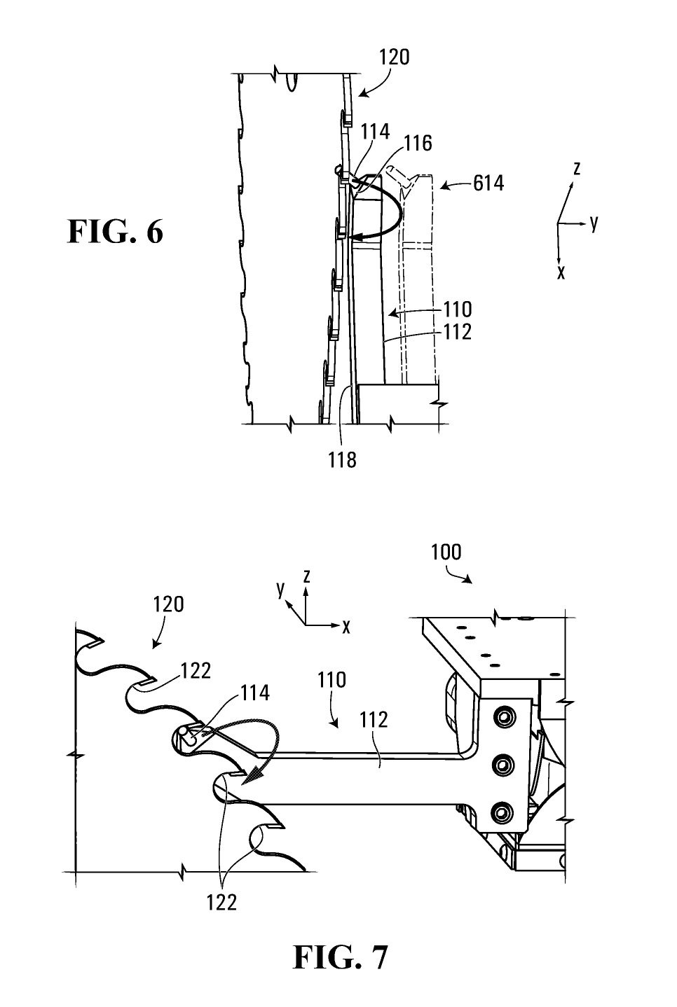

In the side-shift mode, shown in FIG. 6, at least the third motion system 500 is configured to move the feed fingertip 114 of the feed finger 110 in at least the third degree of freedom into and out of a plane of the saw blade 120, to laterally engage with and disengage from a gullet 122 of the saw blade 120, respectively.

In the over-the-top mode, shown in FIG. 7, at least one of the first motion system 300 and the second motion system 400 is configured to move the feed fingertip 114 within the plane of the saw blade 120, to engage with and disengage from the gullet 122, respectively.

In this embodiment, the apparatus 100 is configurable between these two modes by, and more generally is controllable by, a computer processor (not shown) that acts as a Computer Numeric Controller for the larger saw grinding apparatus of which the apparatus 100 is a component. Such a configuration is advantageous not only for providing a side-shift mode, which allows precise automated centering and is generally less prone to jamming of the fingertip upon disengagement from the gullet, but also for providing the user with a choice between the two modes, which may allow the user to better adapt to the challenges posed by a particular saw blade configuration, without having to physically replace the finger feed system's hardware components.

Accordingly, in one aspect of the present disclosure, a computer-readable medium stores instruction codes which, when executed by a computer processor, enable a user to select between side-shift and over-the-top cycling, and cause the apparatus 100 to carry out the selected cycling method, as described below.

### Side-Shift Cycling Mode

In this embodiment, the side-shift cycling mode is used for positioning the feed finger 110 for engagement with the saw blade 120, and generally involves moving the feed finger 110 in three different degrees of freedom.

Referring to FIGS. 1, 6 and 7, in the side-shift mode shown in FIG. 6, at least the first motion system 300 is configured to move the feed fingertip 114 in at least the first degree of freedom to a side position shown in broken outline at 614 in FIG. 6. In this embodiment, the side position 614 is proximate to but spaced apart from the gullet 122 by a spacing having a nonzero component in a direction normal to a plane of the saw blade 120.

More particularly, in this embodiment both the first and second motion systems 300 and 400 are configured to move the feed fingertip 114 to the side position 614 by moving the feed fingertip 114 in at least the first and second degrees of freedom. More generally, depending on the “home” position of the feed fingertip 114, any linear combination of the first, second and third motion systems 300, 400 and 500 may be employed to move the feed fingertip 114 into the side position 614.

As discussed earlier herein, the first degree of freedom comprises X-axis motion in a length direction parallel to the plane of the saw blade 120, the third degree of freedom comprises linear Y-axis motion in a width direction normal to the plane of the saw blade, and the second degree of freedom has a Z-axis motion component in a height direction orthogonal to the length and width directions. More particularly, in this embodiment the second degree of freedom comprises rotational motion about an axis parallel to the width direction, wherein the feed fingertip 114 follows an arcuate path having the Z-axis motion component.

In this embodiment, once the feed fingertip 114 is in the side position 614, at least the third motion system 500 is configured to move the feed fingertip 114 in at least the third degree of freedom from the side position 614 into the gullet 122. Advantageously, by combining linear side-shift engagement with the precision of computer numeric control and the orientation of the feed fingertip 114 discussed earlier herein, the engagement of the feed fingertip 114 can be precisely controlled in a repeatable manner. The combination of the availability of three degrees of freedom including linear Y-axis motion, with the precise motion control provided by the stepper motors of the apparatus 100, allows the feed fingertip 114 to always engage the precise center of the gullet and tooth, and the angled orientation of the feed fingertip ensures that such a precisely centered engagement is possible even when the teeth of the saw blade have shear angles or alternating shear angles, as discussed earlier herein. In this embodiment, the precise automated centering of the feed fingertip 114 on each gullet and tooth is achieved in an open-loop manner, with the magnitude of the required Y-axis translational motion from the side position 614 into the gullet 122 being determined by the processor using a data file specifying the dimensions of the saw blade 120, in conjunction with data from the stepper motors yielding the current position of the feed fingertip. Alternatively, if desired, the centering may be carried out in a closed-loop manner by using a sensor (not shown) to detect the position of the saw blade relative to the feed fingertip 114, and by advancing the feed fingertip 114 until it has extended half-way through the gullet 122 as determined by the detected relative position and the data file specifying the dimensions of the saw blade.

In this embodiment, only linear translational motion in the Y-axis direction is employed to move the feed fingertip 114 from the side position 614 into the gullet 122, and thus only the third motion system 500 is used for this purpose. Alternatively, however, in other embodiments the side position 614 may be replaced with an offset side position, offset from the gullet not only in the Y-axis translational direction but also further offset in at least one of the X-axis translational direction and the Y-axis rotational direction (which has a Z-axis translational component). In such alternative embodiments, either or both of the first and second motion systems 300 and 400 may co-operate with the third motion system 500 to move the feed fingertip 114 diagonally from its offset side position into the gullet 122.

In this embodiment, once the feed fingertip 114 has engaged the gullet 122 of the saw blade 120, at least one of the first and second motion systems 300 and 400 is configured to incrementally advance the feed fingertip 114 in at least one of the first and second degrees of freedom to incrementally advance the saw blade. More particularly, in this embodiment at least the first motion system 300 is configured to incrementally advance the feed fingertip 114 in the X-axis direction (coplanar with the saw blade). If desired, the second motion system 400 may also co-operate with the first motion system 300 by simultaneously moving the feed fingertip 114 vertically (by rotating it about the Y-axis) at the same time as the feed fingertip 114 is advancing in the X-axis direction, to cause the feed fingertip 114 to trace out the same arcuate path that the gullet 122 of the saw blade 120 will follow when it is incrementally advanced.

Once the saw blade 120 has been incrementally advanced by one tooth, in the present embodiment, at least the third motion system 500 is configured to disengage the feed fingertip 114 from the gullet 122 by moving the feed fingertip 114 in at least the third degree of freedom. More particularly, in this embodiment the third motion system 500 moves the feed fingertip 114 along a linear translation in the Y-axis direction out of the gullet 122 and back into the side position 614. Advantageously, by disengaging the feed fingertip 114 through linear translation in the Y-axis direction, the present embodiment reduces the likelihood that the feed fingertip 114 may inadvertently contact and rotate the saw blade during disengagement, in comparison to conventional systems that disengage the feed fingertip using either motion confined to the X-Z plane of the saw blade 120, or short-radius rotation of the feed fingertip out of the saw blade plane, for disengagement.

In this embodiment, after disengagement, at least the first motion system 300 is configured to retract the feed fingertip 114 by moving the feed fingertip 114 away from the saw blade in at least the first degree of freedom, which in this embodiment is linear translation along the X-axis. More generally, retraction may involve moving the feed fingertip 114 to a “home” position, and if the “home” position also differs from the side position 614 in the second and/or third degrees of freedom, then the second and third motion systems 400 and 500 also co-operate in retracting the feed fingertip 114 back to its home position. More generally, however, the feed fingertip 114 need not be returned to a “home” position during each cycle, in view of the full programmability of the motion of the feed fingertip 114 (discussed below).

### Over-the-Top Cycling Mode

Although a side-shift cycling mode as described above may be preferable for most purposes due to the advantages described earlier herein, in view of the large number of possible types of saw blades and saw teeth, it is conceivable that a particular user may prefer an over-the-top cycling mode for at least one type of saw blade. Advantageously, therefore, in this embodiment the apparatus 100 can be switched to an over-the-top cycling mode, without requiring any hardware modifications to the apparatus 100. Instead, the computer processor that acts as the computer numeric controller for the larger saw grinding machine, of which the apparatus 100 is a component, can simply control the apparatus 100 to operate in an over-the-top cycling mode as described below, rather than in a side-shift cycling mode as described above.

In the over-the-top cycling mode, at least one of the first and second motion systems 300 and 400 is configured to move the feed fingertip 114 within the plane of the saw blade 120, to engage with and disengage from the gullet 122 of the saw blade, respectively. More particularly, in this embodiment both the first and second motion systems 300 and 400 are configured to move the feed fingertip 114 in both the first and second degrees of freedom to enter the gullet 122, wherein the first degree of freedom comprises X-axis motion in a length direction parallel to the plane of the saw blade 120, and wherein the second degree of freedom has a Z-axis motion component in a height direction orthogonal to the length direction.

In this embodiment, once the feed fingertip 114 has been engaged with the gullet 122, at least one of the first and second motion systems 300 and 400 is configured to incrementally advance the feed fingertip 114 in at least one of the first and second degrees of freedom to incrementally advance the saw blade 120.

After each incremental advance, in this embodiment, at least one of the first and second motion systems 300 and 400 is configured to disengage the feed fingertip 114 from the gullet 122 by moving the feed fingertip in at least one of the first and second degrees of freedom. More particularly, in this embodiment both the first and second motion systems are configured to disengage the feed fingertip from the gullet by moving the feed fingertip in both the first and second degrees of freedom.

After the feed fingertip 114 has been disengaged from the gullet 122, in this embodiment at least the first motion system 300 is configured to retract the feed fingertip 114 after disengaging it, by moving the feed fingertip away from the saw blade 120 in at least the first degree of freedom.

### Other Cycling Alternatives

In other aspects of the disclosure, different cycling modes may also be provided.

For example, if desired, each of a plurality of additional cycling modes may combine steps and movements of both the side-shift cycling mode and the over-the-top cycling mode described above.

More generally, in this embodiment the processor is fully programmable, to move the feed fingertip 114 to any position in its range of motion. Consequently, the motions of the feed fingertip for a particular cycle are not restricted to linear combinations of the above-described exemplary cycles, but rather, are limited only by the mechanical range of motion of the feed fingertip.

The full programmability of the motion of the feed fingertip 114 is particularly advantageous for saw blades that have variable pitch gullet dimensions on the same blade.

For example, if desired, different alternating motion cycles of the feed fingertip 114 may be used for blades with differently shaped alternating tooth types, with each alternating cycle optimized for a particular respective one of the different alternating tooth types.

Such a full, programmable range of motion over all three degrees of freedom also provides significant advantages over systems in which the feed finger has only one or two degrees of freedom, or systems that provide a third degree of freedom only over a very limited range of motion, such as permitting a wider variety of saw blade types to be processed, and reducing the likelihood of inadvertent rotation of the saw blade when initially engaging and disengaging the feed fingertip 114 within the gullet 122, as discussed above.

While specific embodiments of the invention have been described and illustrated, such embodiments should be considered illustrative of the invention only and not as limiting the invention as defined by the accompanying claims.

What is claimed is:

1. An apparatus for positioning a feed finger engageable with a saw blade, the apparatus comprising:
a first motion system configured to move the feed finger in a first degree of freedom;
a second motion system configured to move the feed finger in a second degree of freedom different than the first degree of freedom; and
a third motion system configured to move the feed finger in a third degree of freedom different than the first and second degrees of freedom, wherein the third degree of freedom comprises linear translational motion in a direction having a non-zero component normal to a plane of the saw blade.

2. The apparatus of claim 1, wherein:
the first motion system is configured to linearly translate the feed finger along a first axis;
the second motion system is configured to rotate the feed finger about a second axis; and
the third motion system is configured to linearly translate the feed finger along a third axis.

3. The apparatus of claim 2, wherein the second axis and the third axis are parallel.

4. The apparatus of claim 2, wherein the first axis and the second axis are orthogonal.

5. The apparatus of claim 2, wherein the third axis is normal to a plane of the saw blade.

6. The apparatus of claim 1, wherein the apparatus is configurable between:
a side-shift mode in which at least the third motion system is configured to move a feed fingertip of the feed finger in at least the third degree of freedom into and out of a plane of the saw blade, to laterally engage with and disengage from a gullet of the saw blade, respectively; and
an over-the-top mode in which at least one of the first and second motion systems is configured to move the feed fingertip within the plane of the saw blade, to engage with and disengage from the gullet, respectively.

7. The apparatus of claim 1, wherein at least the third motion system is configured to move a feed fingertip of the feed finger in at least the third degree of freedom into and out of a plane of the saw blade, to laterally engage with and disengage from a gullet of the saw blade, respectively.

8. The apparatus of claim 6, wherein:
at least the first motion system is configured to move the feed fingertip in at least the first degree of freedom to a side position proximate to but spaced apart from the gullet by a spacing having a nonzero component in a direction normal to a plane of the saw blade; and
at least the third motion system is configured to move the feed fingertip in at least the third degree of freedom from the side position into the gullet.

9. The apparatus of claim 8, wherein the first degree of freedom comprises X-axis motion in a length direction parallel to the plane of the saw blade, and wherein the third degree of freedom comprises Y-axis motion in a width direction normal to the plane of the saw blade.

10. The apparatus of claim 9, wherein at least the first and second motion systems are configured to move the feed fingertip to the side position by moving the feed fingertip in at least the first and second degrees of freedom, and wherein the second degree of freedom has a Z-axis motion component in a height direction orthogonal to the length and width directions.

11. The apparatus of claim 10, wherein the second degree of freedom comprises rotational motion about an axis parallel to the width direction, wherein the feed fingertip follows an arcuate path having the Z-axis motion component.

12. The apparatus of claim 9, wherein at least one of the first and second motion systems is configured to incrementally advance the feed fingertip in at least of the first and second degrees of freedom to incrementally advance the saw blade.

13. The apparatus of claim 12, wherein at least the third motion system is configured to disengage the feed fingertip from the gullet by moving the feed fingertip in at least the third degree of freedom.

14. The apparatus of claim 13, wherein at least the first motion system is configured to retract the feed fingertip after disengaging it by moving the feed fingertip away from the saw blade in at least the first degree of freedom.

15. The apparatus of claim 1, wherein at least one of the first and second motion systems is configured to move the feed fingertip within the plane of the saw blade, to engage with and disengage from a gullet of the saw blade, respectively.

16. The apparatus of claim 15, wherein both the first and second motion systems are configured to move the feed fingertip in both the first and second degrees of freedom to enter the gullet, wherein the first degree of freedom comprises X-axis motion in a length direction parallel to the plane of the saw blade, and wherein the second degree of freedom has a Z-axis motion component in a height direction orthogonal to the length direction.

17. The apparatus of claim 15, wherein at least one of the first and second motion systems is configured to incrementally advance the feed fingertip in at least one of the first and second degrees of freedom to incrementally advance the saw blade.

18. The apparatus of claim 17, wherein at least one of the first and second motion systems is configured to disengage the feed fingertip from the gullet by moving the feed fingertip in at least one of the first and second degrees of freedom.

19. The apparatus of claim 18, wherein both the first and second motion systems are configured to disengage the feed fingertip from the gullet by moving the feed fingertip in both the first and second degrees of freedom.

20. The apparatus of claim 18, wherein at least the first motion system is configured to retract the feed fingertip after disengaging it, by moving the feed fingertip away from the saw blade in at least the first degree of freedom.

21. The apparatus of claim 1, wherein the first motion system is configured to linearly translate the feed finger along a first axis, the second motion system is configured to linearly translate the feed finger along a second axis and the third motion system is configured to linearly translate the feed finger along a third axis.

22. The apparatus of claim 21, wherein the first, second and third axes are orthogonal.

23. A method of positioning a feed finger engageable with a saw blade, the method comprising:
moving the feed finger in a first degree of freedom;
moving the feed finger in a second degree of freedom different than the first degree of freedom; and
moving the feed finger in a third degree of freedom different than the first and second degrees of freedom, wherein the third degree of freedom comprises linear translational motion in a direction having a non-zero component normal to a plane of the saw blade.
